(19) United States
(12) Patent Application Publication
(10) Pub. No.: US 2010/0269292 A1
(43) Pub. Date: Oct. 28, 2010

(54) Block and tackle window balance device

(76) Inventors: Luke Liang, South Plainfield, NJ (US); Tong Liang, Fosham City (CN); David Chen, Poshan City (CN)

Correspondence Address: Thomas A. O'Rourke;Bodner & O'Rourke, LLP, 425 Broadhollow Road, Melville, NY, 11747, US

(21) Appl. No.: 12/386,757

(22) Filed: Apr. 22, 2009

(51) Int. Cl. E05F 7/00

(52) U.S. Cl. 16/199

(57) ABSTRACT

Disclosed are apparatus for a block and tackle window balance to be incorporated in single and double hung window assemblies. In one embodiment the block and tackle window balance includes an improved pulley system that provides smoother, quieter operation. In another embodiment there are stronger channels for protecting the mechanism.

### FIELD OF THE INVENTION

This invention relates to improvements in block and tackle window balance devices for single and double hung windows.

### BACKGROUND OF THE INVENTION

Single and double hung window assemblies generally include a window frame, a lower window sash, an upper window sash, a pair of window jambs, two sets of jamb pockets, and at least one window balance device for offsetting the weight of a window sash through the range of travel within the window frame. Block and tackle window balance devices use a combination of spring and pulleys located within a channel to balance the weight of the window sash at any position within the jamb pockets. Block and tackle window devices for use with single and double hung windows include a channel, a spring with a first end, a translatable pulley block unit, a fixed pulley block unit, a cord, a top guide, and a bottom guide. The top and bottom guides are connected to opposite ends of the channel. The spring, the translatable pulley block unit, and the fixed pulley block unit are all located within the channel. The first end of the spring and the fixed pulley block unit are fixed at opposite ends of the channel. The second end of the spring is connected to the translatable pulley block unit. The translatable and fixed pulley block units are connected by the cord. The cord is threaded around both the translatable and fixed pulley block units and extends around the bottom guide roller located within the bottom guide. An example of a block and tackle device for windows are shown for example in U.S. Pat. Nos. 7,353,567, 7,191,562, 7,143,475, 7,028,371, 6,647,128, 6,41,476 the disclosures of which are incorporated herein by reference. Each of these patents includes a pulley system attached to a spring.

### OBJECT OF THE INVENTION

It is an object to provide a quieter operating block and tackle balance shoe.

It is also an object of the invention to provide an improved pulley system for window balance devices.

It is an additional object of the invention to provide an improved balance system that can be used in a variety of window applications.

It is another object of the invention to provide a more durable window balance device.

It is a further object of the invention to provide a pulley assembly for a block and tackle balance system that could be used with an inverted balance shoe system.

It is another object of the invention to provide a pulley system that could be used with a tilt balance system.

It is a still further objection of the invention to provide a pulley system that can be used in a side load balance system.

### SUMMARY OF THE INVENTION

The block and tackle window balance system of the present invention include a spring, translatable or movable pulley unit, a fixed pulley unit, rollers, and a cord all housed with the rigid U-shaped channel. Attached to at least one end of the rigid U shaped channel is means to used to connect the window balance to either the upper or lower window sashes. The means can include a means for securing a cord to a window or frame or a guide. At an opposite end of the U-shaped channel is a balance shoe or a guide to help guide the vertical motion of the window balance within the jamb pockets.

The rigid U-shaped channel has a back wall and two side walls that in combination form the U-shaped channel. The rigid U-shape channel serves as an external frame to which components of the window balance can be secured. The rigid U-shaped channel also keeps components located within the rigid U-shaped channel free of debris. The spring, the movable pulley unit and the fixed pulley unit are each located inside the rigid U-shaped channel. The present invention includes a fixed pulley assembly that has a first axle with one or more rollers rotatably mounted thereon and a second axle with one or more rollers rotatably mounted thereon. Preferably the fixed pulley unit has a first axle with two or more rollers rotatably mounted on the axle. In another embodiment there are three rollers on the axle.

Components within the rigid U-shaped channel work in combination to create a force to counterbalance the weight of the attached sash at any vertical position within the window frame. These components are attached to each other such that a first end of the spring is connected to the moveable pulley unit and the moveable pulley unit is connected to the fixed pulley unit and the roller via the cord.

The u-shaped channel of the present invention has one or more corrugations or dimples arranged on a surface thereof. The corrugations may preferably extend from one end of the u-shaped channel to the other end of the u-shaped channel. Instead of corrugations there may be plurality of dimples in the surface of the channel. These corrugations and/or dimples increase the strength of the u-shaped channel or alternatively permit a thinner material to be used in the making of the unshaped channel.

### BRIEF DESCRIPTION OF DRAWINGS

FIG. 1 is a perspective view of an example system of the balance system of the present invention where there is a fixed pulley structure with multiple axles and a movable pulley structure. The assembly of FIG. 1 may be used, for example, as an inverted balance system or as a tilt balance system.

FIG. 2 is an exploded view of the balance system assembly of FIG. 1.

FIG. 3 is an exploded view of an example of the fixed pulley assembly used in FIG. 1.

FIG. 4 is a perspective view of two exemplary rollers that may be used in the fixed pulley system of FIG. 4.

FIG. 5 is a side view of a roller of the type that can be used in the present invention.

FIG. 5A is an end view of an example of a roller with one and a half grooves.

FIG. 5B is an end view of a roller with three grooves.

FIG. 5C is an end view of a roller with one groove.

FIG. 6A is a side perspective view of the fixed pulley assembly with the cord laced for an inverted balance system.

FIG. 6B is a side cut away view of the fixed pulley assembly showing the cord arrangement of FIG. 6A

FIG. 6C is a side perspective view of the fixed pulley assembly with the cord laced for a tilt balance system

FIG. 6D is a side cut away view of the fixed pulley assembly showing the cord arrangement of FIG. 6C.

FIG. 7 A shows a portion of the cord arrangement over the rollers for a tilt balance system as the cord is exiting the assembly.

FIG. 7B shows a portion of the cord arrangement over the rollers for inverted balance system as the cord is exiting the assembly

FIG. 7C shows a side view of the fixed pulley assembly frame

FIG. 8A shows an example of one means of assembly for the fixed pulley assembly frame.

FIG. 8B shows an example of a second means of assembling the fixed pulley assembly frame.

FIG. 9A-9B show examples of two different cord lace arrangement between the fixed pulleys and the moving pulleys for an inverted balance system.

FIGS. 9C-9D show an example of two different cord lace arrangements between the fixed pulleys and the moving pulleys for a tilt balance system.

FIG. 10A shows a side view of the fixed pulley assembly with the cord positioned for an inverted balance system.

FIG. 10B shows a top view of the fixed pulley assembly of FIG. 10A.

FIG. 10C shows a side cut away view of the fixed pulley assembly FIG. 10A.

FIG. 10D shows an end view of the fixed pulley assembly FIG. 10A.

FIG. 11 shows a perspective view of an example of a side load balance system of the present invention.

FIG. 12 is an exploded view of the balance shoe and channel assembly of FIG. 11.

FIG. 13 is an exploded view of the fixed pulley assembly of the embodiment of FIG. 11.

FIG. 14 is a side cutaway view of the fixed pulley assembly of FIG. 11 showing the cord end as it leaves the U-shaped channel to be secured to a hook.

FIG. 15 is a schematic view of the cord winding of FIG. 14

FIG. 16A and B show two schematic views of the cord lacing for the fixed and moving pulley assemblies where there is a side load balance system.

FIG. 17A shows a perspective view of the U-shaped channel in the present invention.

FIG. 17B shows a top view of the U-shaped channel of FIG. 17A.

FIG. 17C shows a side view of the U-shaped channel of FIG. 17A.

FIG. 17D shows a bottom view of the U-shaped channel of FIG. 17A.

FIG. 17E shows a cutaway view of the U-shaped channel taken along section F-F.

FIG. 18A shows a perspective view of an alternative embodiment of the U-shaped channel in the present invention.

FIG. 18B shows a top view of the U-shaped channel of FIG. 18A.

FIG. 18C shows a side view of the U-shaped channel of FIG. 18A.

FIG. 18D shows a side view of the U-shaped channel of FIG. 18A.

FIG. 18E shows a cutaway view of the U-shaped channel taken along section F-F.

FIG. 19A shows a perspective view of an alternative embodiment of the U-shaped channel in the present invention.

FIG. 19B shows a top view of the U-shaped channel of FIG. 19A.

FIG. 19C shows a side view of the U-shaped channel of FIG. 19A.

FIG. 19D shows a bottom view of the U-shaped channel of FIG. 19A.

FIG. 19E shows a cutaway view of the U-shaped channel taken along section F-F.

FIG. 20A shows a perspective view of an alternative embodiment of the U-shaped channel in the present invention.

FIG. 20B shows a top view of the U-shaped channel of FIG. 17A.

FIG. 20C shows a side view of the U-shaped channel of FIG. 17A.

FIG. 20D shows a bottom view of the U-shaped channel of FIG. 17A.

FIG. 20E shows a cutaway view of the U-shaped channel taken along section F-F.

FIG. 21A shows a perspective view of an alternative embodiment of the U-shaped channel in the present invention.

FIG. 21B shows a top view of the U-shaped channel of FIG. 21A.

FIG. 21C shows a bottom view of the U-shaped channel of FIG. 21A.

FIG. 21D shows a side view of the U-shaped channel of FIG. 21A.

FIG. 21E shows a cutaway view of the U-shaped channel taken along section F-F.

FIG. 22 is an exploded view of the moving pulley assembly of the embodiment of FIG. 11.

FIG. 23 is a top view of the movable pulley assembly with the cord and the spring.

FIG. 24A is a side view of the movable pulley housing.

FIG. 24B is a top cut away view of the pulley housing of FIG. 24A

FIG. 24C is a perspective view of the pulley housing of FIG. 24A.

FIG. 24D is a perspective view of the pulley housing of FIG. 24 A taken from the opposite end of FIG. 24C.

FIG. 24E is a view of the pulley housing taken along A-A FIG. 24F is a portion of the top surface and bottom surface of the left end of pulley housing of FIG. 24A.

FIG. 25A-D are alternative embodiments of the movable pulley housing with the cord end portion rotated 90°.

### DETAILED DESCRIPTION OF THE INVENTION

The present invention is directed to a balance system that may be used in a variety of applications including, but not limited to as a tilt balance system, an inverted balance system and a side load balance system

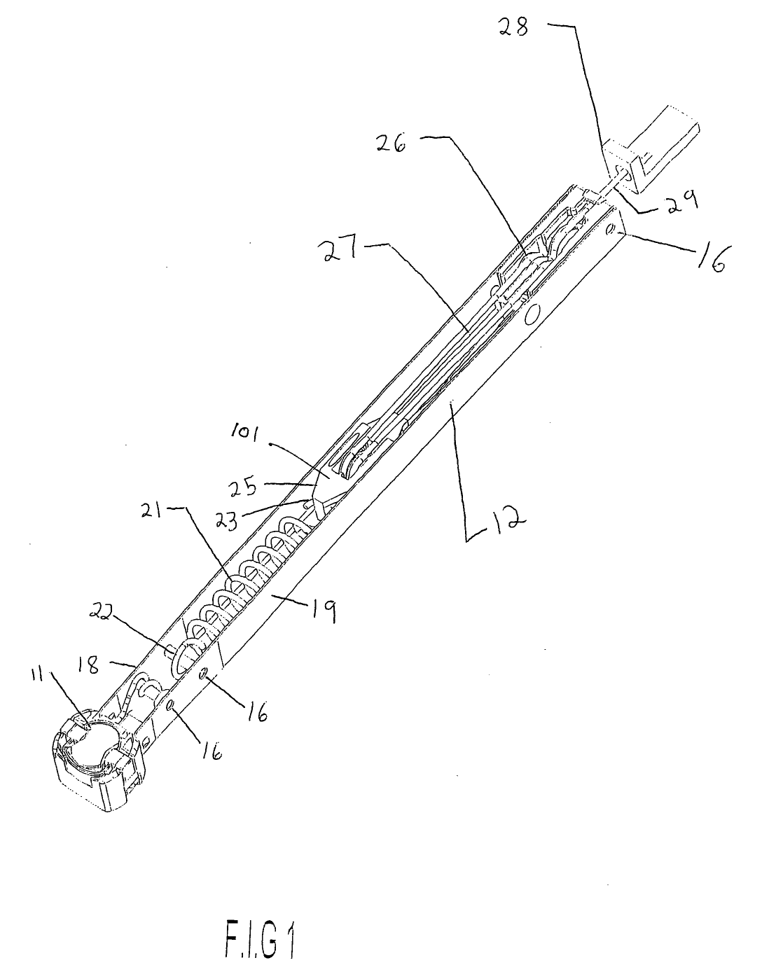

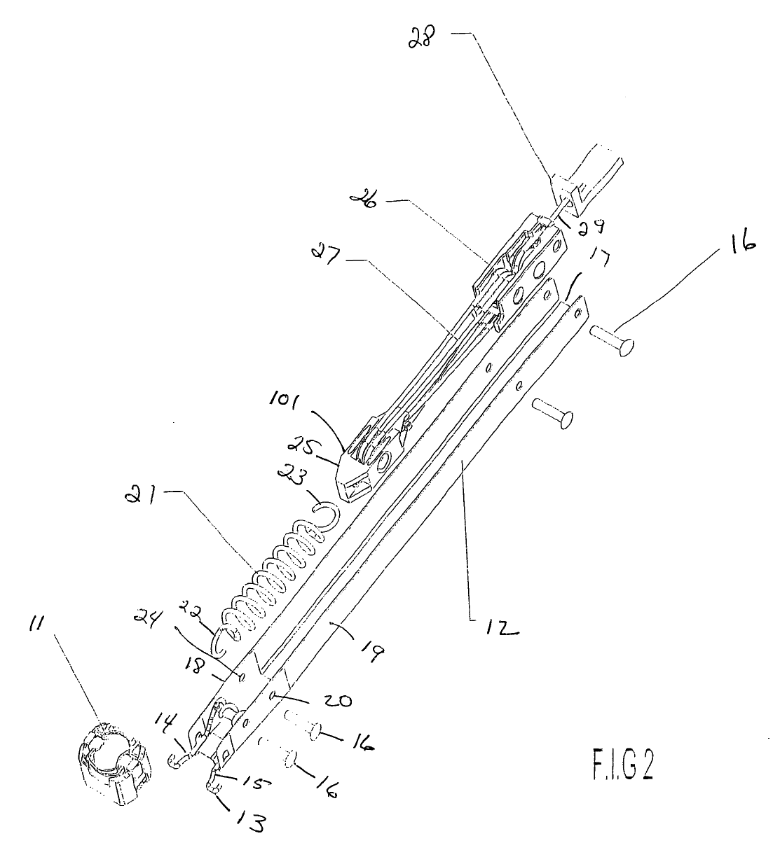

A balance shoe assembly 10 for a tilt or inverted balance system is shown in FIG. 1. The assembly has a representative balance shoe 11 that is secured to a u-shaped channel 12 by a clip 13 or other means. In one embodiment, the clip 13 may have a first leg 14 and a second leg 15 that are secured to the u-shaped channel by a pin 16. The details of the operation of one example of the balance shoe and its connection to a U-shaped channel is described in co-pending U.S. patent application Ser. No. 12/2189,764 filed Jul. 17, 2008, the disclosures of which are incorporated herein by reference.

The U-shaped channel 12 has a generally flat base 17 that extends the length of the channel and a pair of opposite sidewalls 18 and 19 extending upwardly from the base. The sidewalls are preferably generally at right angles to the base and extend upwardly from the opposite edges of the base. The base and sidewalls may be made of a single piece of sheet metal bent into the desired shape. The base may have one or more orifices therein to reduce weight or for other reasons. The U-shaped channel may have one or more orifices 20 in the sidewalls to permit a pin or other suitable means for securing to pass from one sidewall of the U-shaped channel to the other. Inside the U-shaped channel is positioned a spring 21 having a plurality of coils and a first end 22 and a second end 23. Each of the ends has a hook or other securing means. The first end 22 of the spring is secured to a pin 16 that passes through orifice 20 and 24. The hook 22 may also be secured to the pin 16 that is connecting the balance shoe 11 to the channel. The second end 23 of the spring is secured to the movable pulley assembly 25. The movable pulley assembly travels within the channel and is connected to a fixed pulley assembly 26 by means of a thread or cord 27. The cord has a first end 29 secured to a means for securing the block and tackle assembly to a window or window sash. One example of such a means is a generally “L” shaped clip 28. The L-shaped clip 28 has a base portion 28A with an orifice for receiving the string, a knot in the string secures the cord to the clip.

The fixed pulley assembly 26 has a frame 41. The frame 41 has a first sidewall 42 and a second sidewall 43. The first and second sidewalls 42 and 43 have axles, 44 and 45 that extend from one sidewall to the other sidewall. On first axle 44 is a roller 46 with a plurality for receiving the cord or string which is threaded about the assembly. In a preferred embodiment there are two or three grooves on the roller on axle 44. The rollers are rotatably mounted on the axle. The roller may also be made up of two or more separate or individual rollers 47 and 48 which have one and a half grooves each. These rollers are placed side by side to form a roller assembly with the three grooves. The second axle 45 has a single roller rotatably mounted to the axle.

The sidewalls of the frame are connected by, for example, a front bar 48 and a rear bar 49. Thereby forming an open area for receiving the rollers. The frame is secured to the U-shaped channel by any suitable means. In one example, the sidewalls of the frame of the fixed pulley assembly may have an orifice on each sidewall that permits a pin (not shown) to pass through the sidewalls of the pulley assembly and the U-shaped channel to retain the front end of the pulley assembly to the channel. In another embodiment, shown in FIG. 8B, front bar 48 may be a top surface 50 and a rear surface 51. The top surface 50 and rear surface 51 form a recess area in conjunction with the first side wall tongue 52 and the second sidewall tongue 53 for a pin to pass and thereby retain the front end of the fixed pulley assembly in the U-shaped channel. In the embodiment shown in FIG. 8A each tongue has a base section 54 and an end surface 55 and a curved recessed area 56 to mate or conform with the circumference of the pin 16. As seen in FIG. 8A, the frame of the fixed pulley assembly can have an alternative means of securing the front end of the frame to the U-shaped channel. In this embodiment the first and second sidewalls are secured by a bar. The bar extends from one sidewall to the other. Extending from the end of the frame by the front bar are first and second sidewall tongues 52 and 53. These sidewall tongues each have a base section 54 and an end edge 55.The top surface of the base section 54 has a flange 57 extending outwardly of the frame of the sidewalls. The flange 57 is adapted to be received in an orifice 58 in the sidewall of the U-shaped channel. The flange is shown having a flat top surface 58, a bottom surface portion 59 and a end wall. The flange is adapted to recess slightly inwardly as the frame is inserted in the channel so that the flanges can pass the top surface 60 of the channel. When the flanges reach the orifice 61 in the sidewall of the U-shaped channel, the flange is released outwardly and enters the orifice thus securing that end of the frame to the channel. The flange is shown with a generally flat top surface and bottom surface as described above, but it will be appreciated that the shape of the flange and the respective opening in the sidewall of the channel can vary so long as the flange can be slightly retracted or the sidewalls of the U-shaped channel can be slightly expanded to permit the flange to pass the top edge 60 of the U-shaped channel. The rear of the fixed pulley assembly frame may have orifices 63 that line up with the orifices 62 in the channel. A pin can be inserted through the orifices to secure the rear end of the frame to the channel. Other suitable connecting means can be used to secure the frame to the channel if desired.

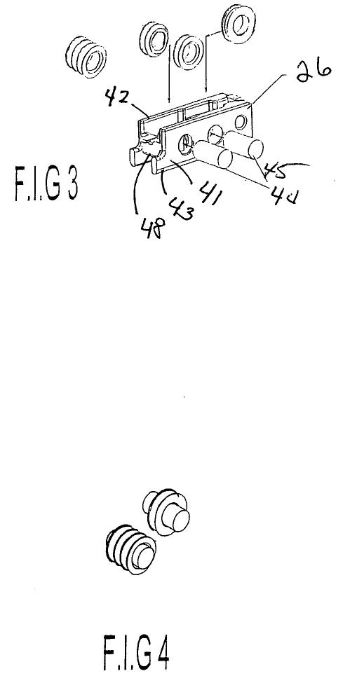

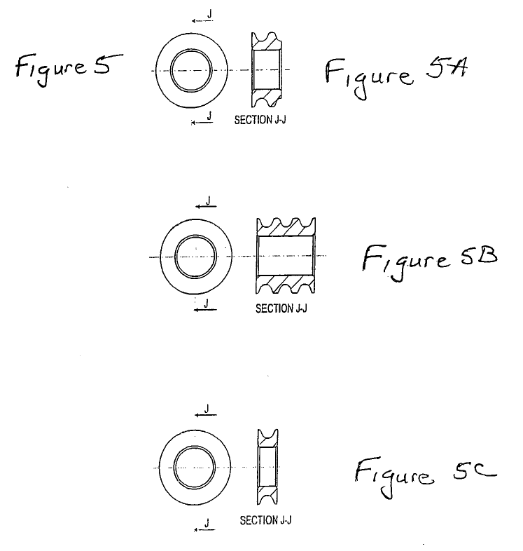

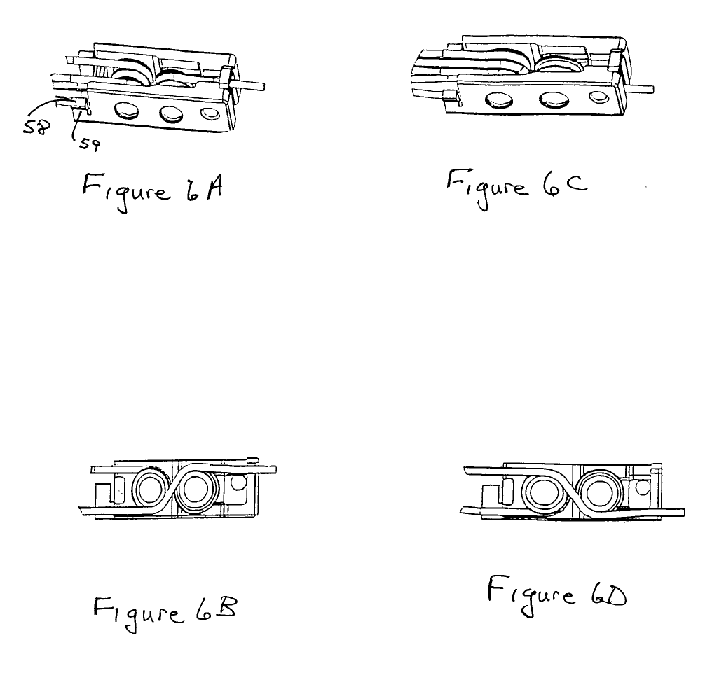

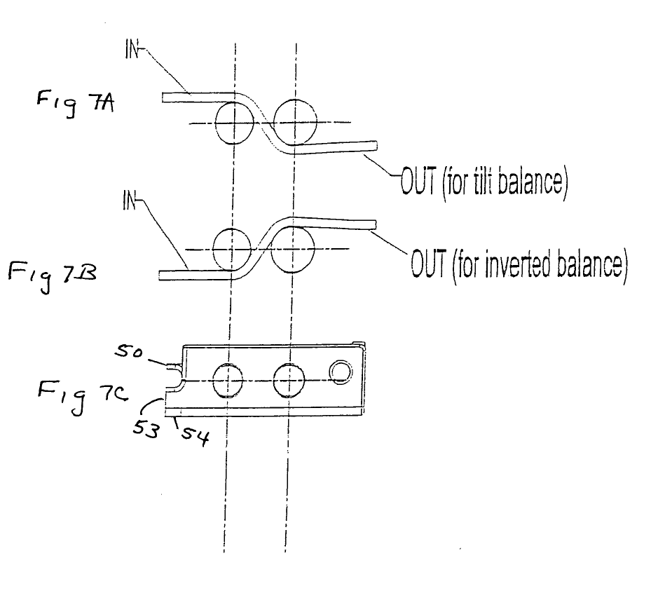

As seen in FIG. 13, the fixed pulley assembly in either the embodiment of FIG. 1 or FIG. 11 may be formed from a first sidewall member 64 and a second sidewall member 64A that may be secured together to form the assembly. The sidewall members may have a first orifice 65 and a second orifice 66 that receive an axle 67. The axle may have a bushing 68 thereon to facilitate rotation of the rollers 46. Each of the sidewall members have the orifices 65 and 66 lined up so that the axle 67 can extend from one sidewall to the other and pass through the orifices. It will be appreciated by those skilled in the art that instead of orifices and an axle there maybe an inner sidewall of the sidewall member without orifices and a pin or other protrusion, with a generally circular cross section on which the rollers 46 and or bushing can rotate. The rollers have a recessed section 69 with lips 70 and 71 to retain the cord 72 in position. FIGS. 3 to 5 show representative examples of the rollers that may be used.

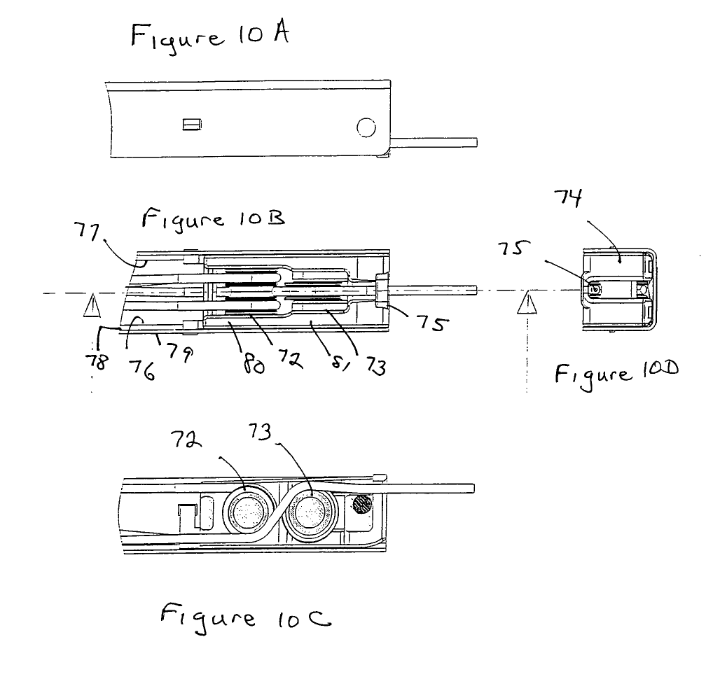

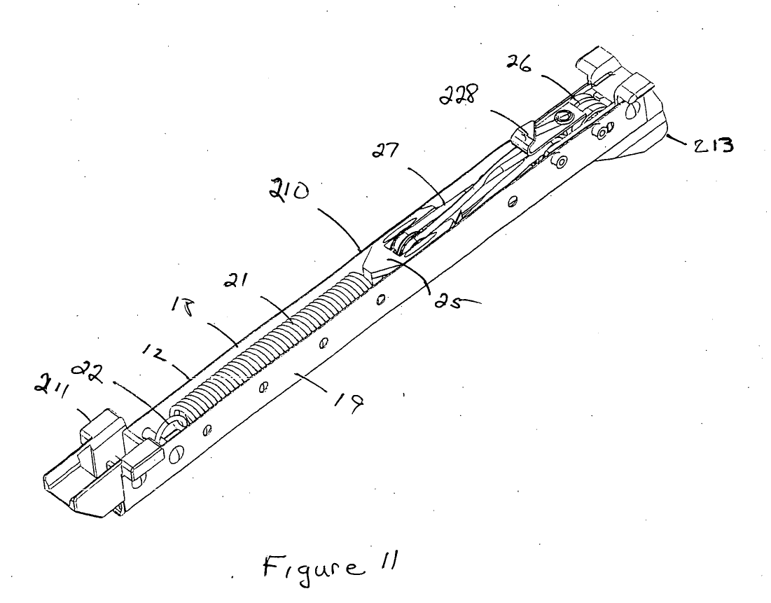

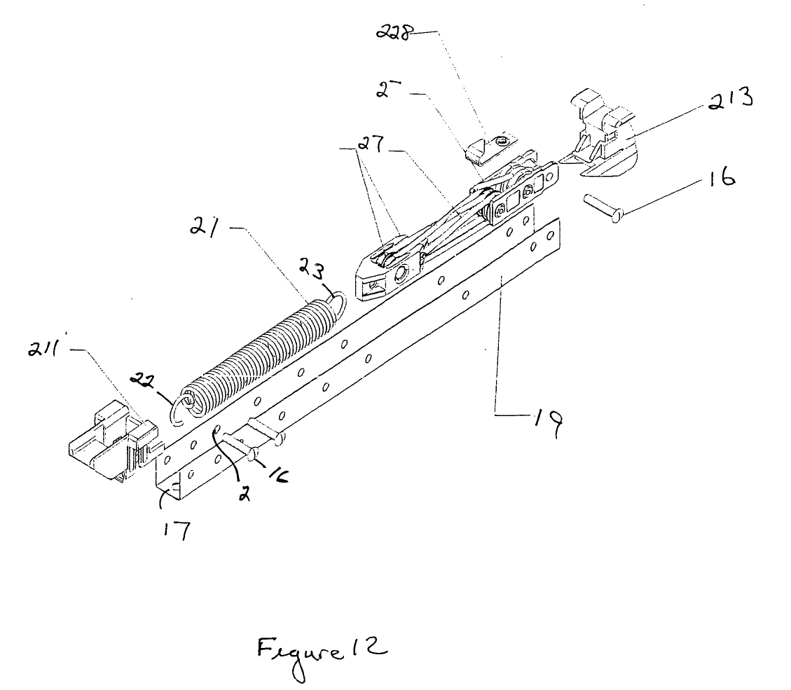

As seen in FIGS. 10A to 10C, the fixed pulley assembly has first 72 and second 73 roller assemblies that have rollers that rotate about their axes. The fixed pulley assembly has a rear wall 74 that extends generally from one sidewall to the other sidewall of the assembly. The rear wall is provided with an orifice or slot 75 to permit the cord to extend outwardly of the fixed pulley assembly. The inner sidewalls 76, 77 of the fixed pulley assembly may be generally smooth and straight or if desired to get the alignment of the rollers in the proper arrangement there may be tapering of the sidewalls as seen in FIG. 10B. The inner sidewall of the fixed roller assembly may have an end wall 78 that joins the inner sidewall 76 to the outer sidewall 79. The inner sidewall 76 and the outer sidewall 79 form a first thickness in the region without the rollers. There is a second thickness 80 in the region of the first pair of rollers and a third greater thickness 81 in the region of the second single roller. The difference in the thickness on either side of the sidewalls prevent side to side travel of the rollers when they are rotating about the axis.

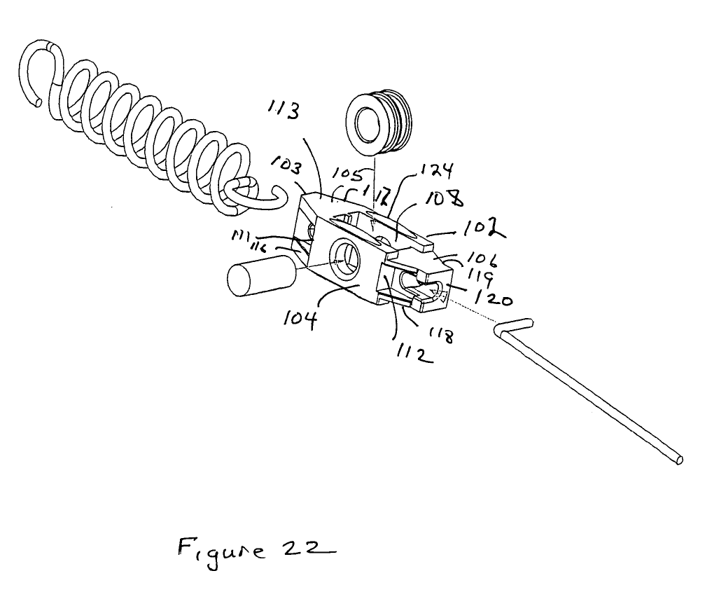

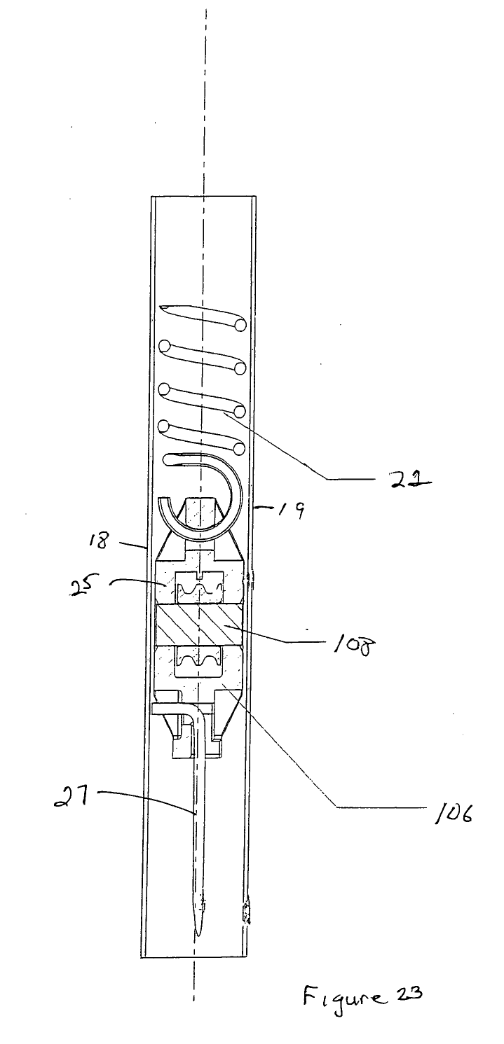

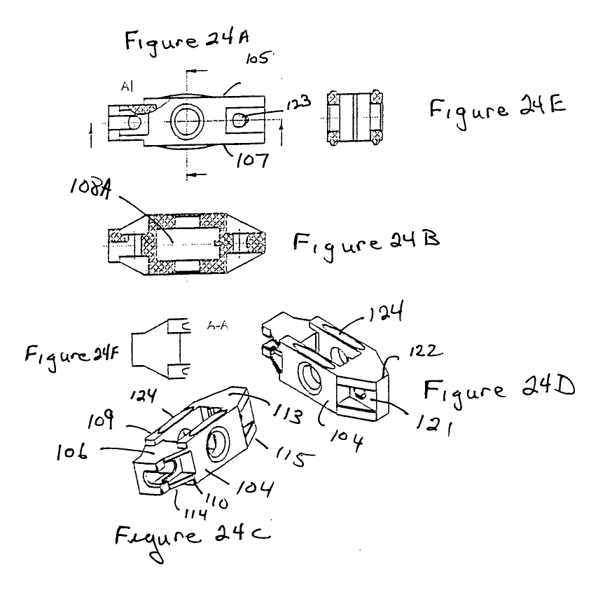

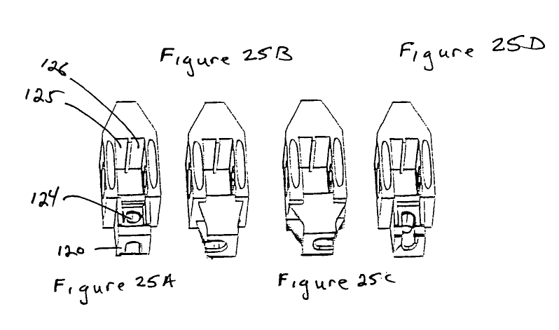

In addition to the fixed roller assembly there is a movable roller assembly 101 as shown in detail in FIGS. 22 to 25. The movable roller assembly shown in FIG. 22 to 25 may be used in either the embodiment of FIG. 1 or the embodiment of FIG. 11. The movable roller assembly 101 is secured to the spring at one end 103. The movable roller assembly has a frame 102 with a first side wall 104 and a second sidewall 108. The first and second sidewalls are joined together by a top surface 105 and a bottom surface 107. The frame has an open area 108A for receiving one or more rollers. The sidewall 104 and 108 have a generally rectangular area that is aligned with the sidewall of the U-shaped channel. The rectangular area has an orifice for receiving a pin that supports a roller. The rectangular area has a top edge 109 and a bottom edge 110 that are joined by a left side edge 111 and a right side edge 112. Extending from each of the side edges, generally in the area of the top edge, edge are the left top portion 113 and the right top portion 106. The left and right top portion form with the top edge of the sidewalls an open area 108A for receiving the roller. Similarly, the extending from each of the side edges generally in the area of the bottom edge are the left bottom portion 114 and the right bottom portion 115. The left and the right bottom portion form with the bottom edge of the sidewalls an open area for receiving the roller. The sides of the top 116, 117 and bottom left portions and the sides 118, 119 of the top and bottom right portions preferably taper towards the center axis of the fixed roller assembly. The right top and bottom portions end in a end wall that extends from the top right potion to the bottom right portion. The end wall 120 has a generally U shaped cut out in its surface for receiving the cord so the cord can be wrapped around the roller.

The left top and bottom portions are joined by a center wall 121 extending from an end wall of the opening formed by the area for receiving the roller and its axle to the end edge 122 of the top and bottom portions. The center wall 121 is generally perpendicular to the right top and bottom portions. The center wall is provided with an opening 123 so that one end of the spring can be hooked through the orifice. The top and bottom edges of each sidewall of the movable pulley assembly are provided with a raised arcuate member 124 that is positioned adjacent the roller. This arcuate member is higher at its center than at its edges and is present on both the top edges of the sidewalls and both of the bottom edges. This arcuate member raises the top and bottom surfaces of the movable pulley assembly away from the bottom inner surface of the U-shaped channel. This reduces the amount of friction the movable pulley assembly may encounter thereby rendering it easier for the assembly to move in the U-shaped channel.

FIGS. 25A to D show four configurations of the movable pulley assembly. In each of these configurations the cord end 120 of the assembly i.e., the end of the assembly which has the U-shaped opening for receiving the cord as it is wrapped over a portion of the roller is rotated 90°. Thus, in the first configuration, the U-shaped end is upside down. In the second, the U-shaped end opens on the left. In the third, the U-shaped end opens to the right. In the fourth configuration the U is in its usual position with the open area towards the top. The moveable pulley assembly may also have a wall extending from one sidewall of the frame to the other sidewall of the frame. This end wall is between the end wall 120 and the roller and is provided with an opening 124 for receiving the cord as it passes from one end wall to the roller. The opposite end of the frame may have a solid wall extending from one sidewall to the other sidewall or there may be two open areas 125, 126 on either side of the perpendicular center wall.

FIG. 11 shows a side load balance shoe assembly 210. The assembly has a representative top guide 211 that is secured to a U-shape channel 12 by a suitable means.

The U-shaped channel 12 has a generally flat base 17 that extends the length of the channel and a pair of opposite sidewalls 18 and 19 extending upwardly from the base. The sidewalls are preferably generally at right angles to the base and extend upwardly from the opposite edges of the base. The base and sidewalls may be made of a single piece of sheet metal bent into the desired shape. The base may have one or more orifices therein to reduce weight or for other reasons. The channel may have one or more orifices 20 in the sidewalls to permit a pin or other suitable means for securing to pass from one sidewall of the U-shaped channel to the other. Inside the U-shaped channel is positioned a spring 21 having a plurality of coils and a first end 22 and a second end 23. Each of the ends has a hook or other securing means. The first end 22 of the spring is secured to a pin 16 that passes through orifice 20 and 24. The hook may also be secured to the pin 16 that is connecting the balance shoe 11 to the channel. The second end 23 of the spring is secured to the movable pulley assembly 25. The movable pulley assembly travels within the channel and is connected to a fixed pulley assembly 26 by means of a thread or cord 27. The cord has a first end 29 secured to a means for securing the block and tackle assembly to a window sash or window frame. One example of such a means is a generally hook shaped clip 228. The hook shaped clip is secured to the end of the cord 27. At the end of the U-shaped channel is a guide 213. The guide is a bottom guide.

As noted above, the U-shaped channel 12 has a base with a pair of side walls extending upwardly from the base. The sidewalls are generally perpendicular to the base. The base has an inner surface and an outer surface. Similarly the sidewalls have an inner surface and an outer surface. There may be a plurality or orifices in the sidewalls and base for securing the fixed pulley member to the channel. There may also be one or more orifices in the channel for securing the balance shoe to the channel if desired. Alternatively the sidewalls and base may have one or more protruding members or other means for securing the fixed pulley member to the U-shaped channel. Similarly the balance shoe of the device may be secured to the channel by one or more protruding members extending from the base or the sidewalls of the U-shaped channel that permit the balance shoe or the fixed pulley assembly to snap into the channel due to corresponding recesses that line up with the protruding members on the U-shaped channel.

The sidewalls and base of the U-shaped channel may be, except for the orifices, a relatively smooth surface of sheet metal or plastic. If sheet metal the channel can be extruded into its U-shape or a single sheet metal portion may be bent to form the U-shape channel.

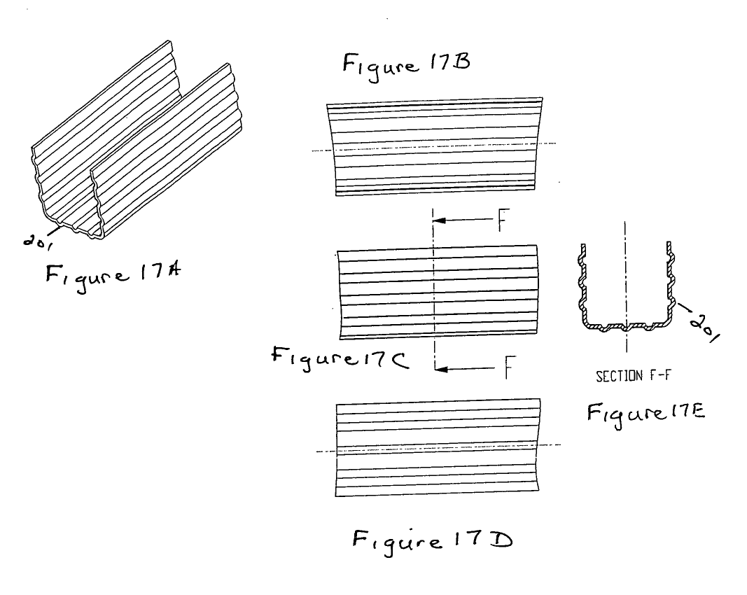

In one embodiment of the invention shown in FIGS. 17 and 18, the U-shaped channel may be provided with one or more corrugations 201 in the surface of the U-shaped channel The corrugations preferably extend along the entire length of the U-shaped channel. The corrugations may have a first and second sidewall that meet at an angle. Also the corrugations may have a first sidewall, a base portion and a second sidewall. The sidewalls may be generally parallel to each other but don't have to be, similarly the base portion may be generally perpendicular to the two sidewall portions. While the drawings show the entire surface of the U-shaped channel with a plurality of corrugations it will be appreciated by those skilled in the art that an one or more of the sidewalls or base may have one or more corrugations.

In still a further embodiment, the sidewalls may have curved corrugations instead of corrugations with an angle between the members of the corrugation. See FIGS. 17A to E, FIGS. 18A to E, and FIG. 21. Alternatively, the sidewalls may have fins extending outwardly from the interior or exterior surface of the U-shaped channel.

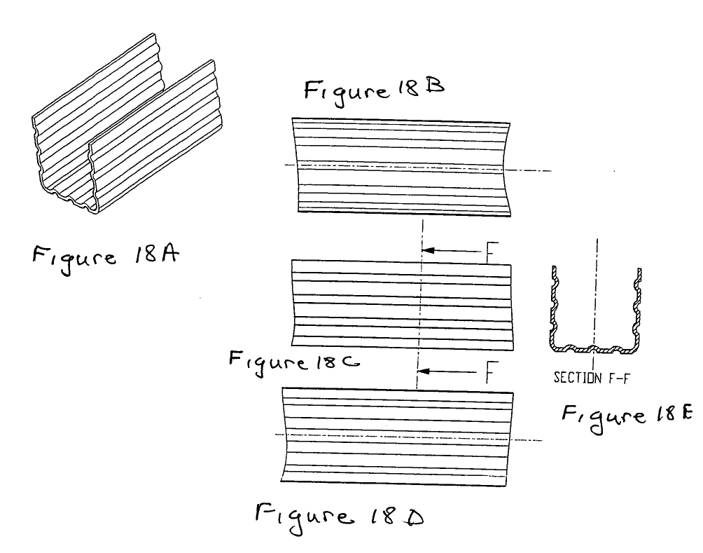

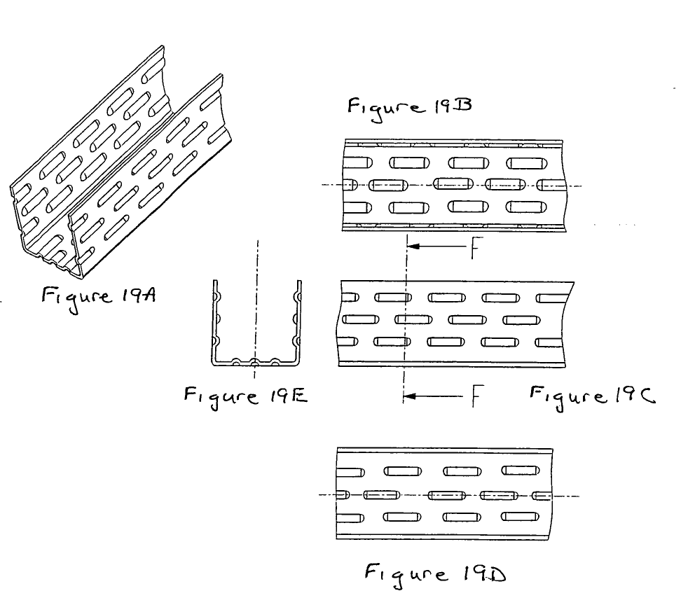

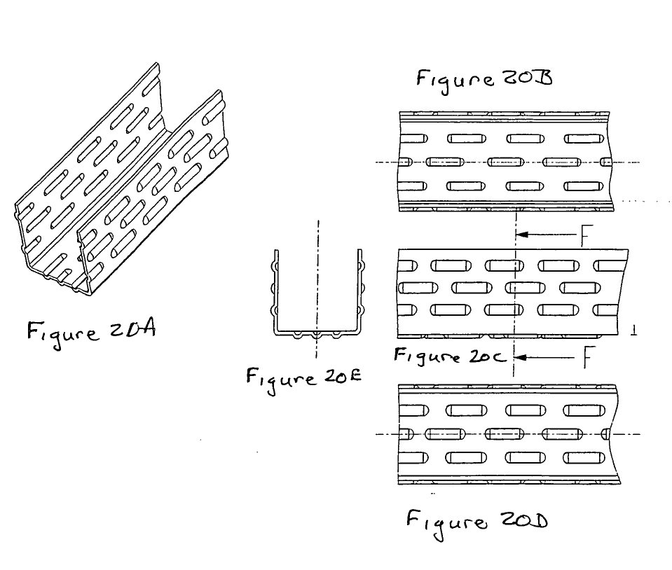

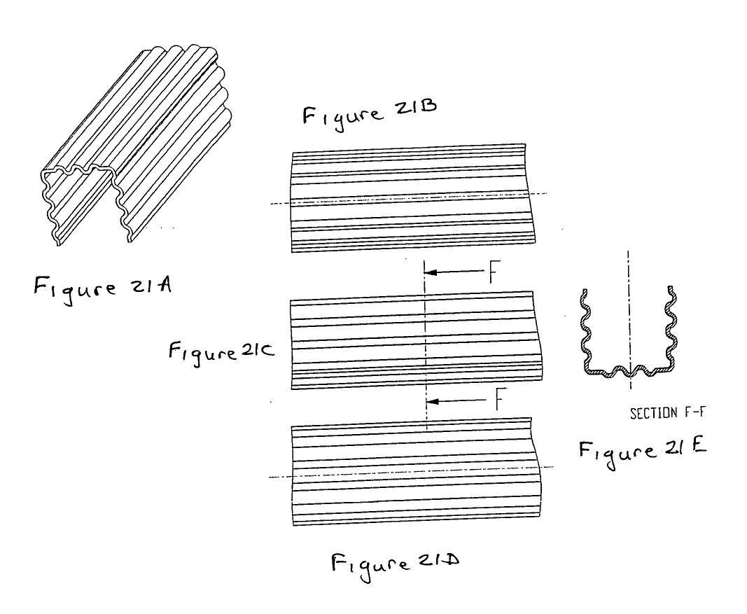

In a still further embodiment, one or more of the sidewalls and base of the U-shaped channel may have one or more dimples extending inwardly or outwardly of the surface of the sidewall or base. See FIGS. 19 and 20. The dimples may be any shape including but not limited to, semi-hemispherical conical etc.

The dimples may be aligned so that a series of them form straight lines along the surface of the U-shaped channel or they may be in any other type pattern or no pattern at all. The dimples may have a longitudinal body with generally straight sidewalls and a generally flat top surface. There may be an end wall present at each end generally perpendicular to the sides. In an alternative embodiment the dimple may have a base that is generally straight where the dimple meets the surface of the U-shape channel. There may be a curved body portion extending from one side of the base to the other side of the base forming a U-shaped surface. There may be curved end members at either end of the dimples as seen in FIG. 19A and 20A. Those skilled in the art will appreciate that the dimple may have a number of different shapes and configurations.

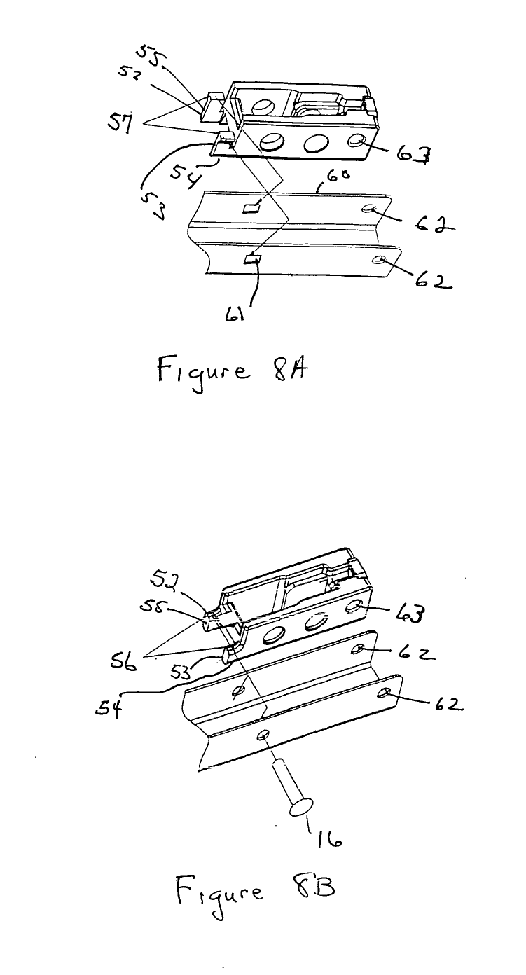

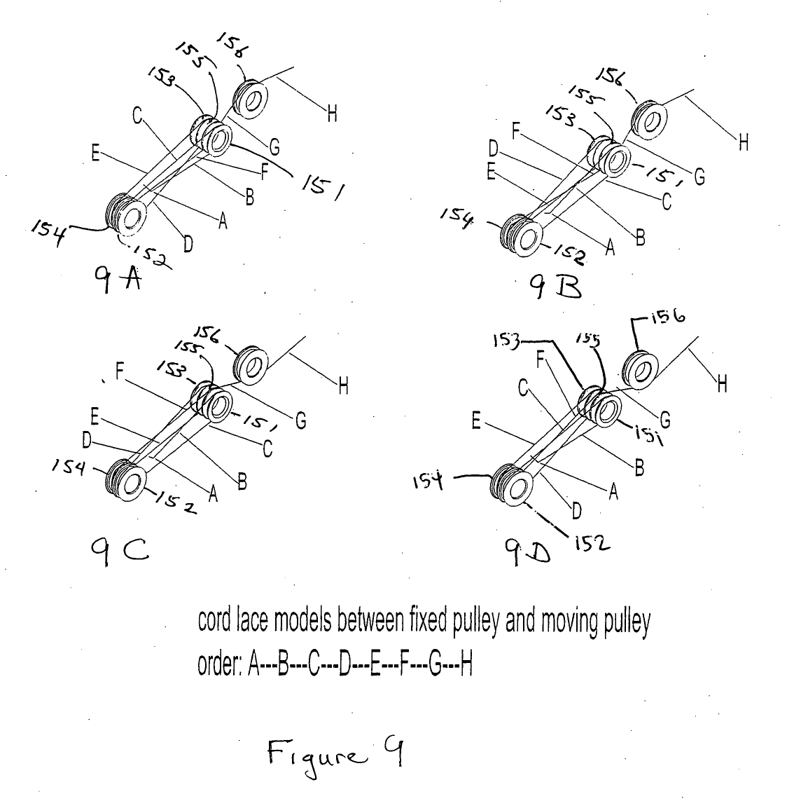

FIG. 9 shows examples of how the cord may be configured about the pulleys. One end of the cord is designated A in each of the figures. The opposite end of the cord is designated H. FIGS. 9A and 9B show representative examples of how the cord may be wound about the roller assembly on a single axis in the movable pulley assembly and the dual axle arrangement of the fixed roller assembly. FIG. 9A and 9B show the arrangement for a inverted balance shoe assembly. FIG. 9C and D show the arrangement for a tilt balance shoe.

In FIG. 9A starting at end A the cord B is wrapped under the roller 151 on the first fixed pulley assembly axle and over the top of roller 151 and extending C to right roller 152 on the movable pulley assembly. The cord goes over the right roller 152. When it reaches the underside it crosses D over to the left roller 153 on the first axle of the fixed pulley assembly where it goes under roller 153 and comes out over the top E where the cord extends to the left roller 154 on the movable pulley assembly. The cord F goes over the top of roller 154 and comes from the bottom of left roller 154 where it extends to the center roller 155 of the first axle of the fixed pulley assembly. The cord goes under the center roller 155 of the axle and then passes G over roller 156 on the second axle of the fixed pulley assembly where it ends at H.

In FIG. 9B starting at end A the cord B is wrapped over the roller 151 on the first fixed pulley assembly axle and under the bottom of roller 151 and extending C to right roller 154 on the movable pulley assembly. The cord goes under the right roller 154. When it reaches the top side it crosses D over to the left roller 153 on the first axle of the fixed pulley assembly where it goes over roller 153 and comes out under the bottom where the cord extends E to the left roller 154 on the movable pulley assembly. The cord goes over the top of roller 154 and comes from the bottom of left roller 154 where it extends F to the center roller 155 of the first axle of the fixed pulley assembly. The cord goes under the center roller 155 of the axle and then passes G over roller 156 on the second axle of the fixed pulley assembly where it ends at H.

In FIG. 9C starting at end A the cord B is wrapped under the roller 151 on the first fixed pulley assembly axle and under the bottom of roller 151 and extending C to right roller 152 on the movable pulley assembly. The cord goes under the right roller 152. When it reaches the top side it crosses over D to the left roller 153 on the first axle of the fixed pulley assembly where it goes over roller 153 and comes out under the bottom where the cord extends to the left roller 154 on the movable pulley assembly. The cord E goes under the bottom of roller 154 and comes from the top of left roller 154 where it extends F to the center roller 155 of the first axle. The cord goes over the center roller 155 of the axle and then passes G under roller 156 on the second axle of the fixed pulley assembly where it ends at H.

In FIG. 9D starting at end A the cord B is wrapped under the roller 151 on the first fixed pulley assembly axle and under the bottom of roller 151 and extending C to right roller 152 on the movable pulley assembly. The cord goes under the right roller 152. When it reaches the underside it crosses over D to the left roller 153 on the first axle of the fixed pulley assembly where it goes under roller 153 and comes out over the top where the cord extends E to the left roller 154 on the movable pulley assembly. The cord goes over the top of roller 154 and comes from the bottom of left roller 154 where it extends F to the center roller 155 of the first axle. The cord goes over the center roller 155 of the axle and then G passes under roller 156 on the second axle of the fixed pulley assembly to end at H.

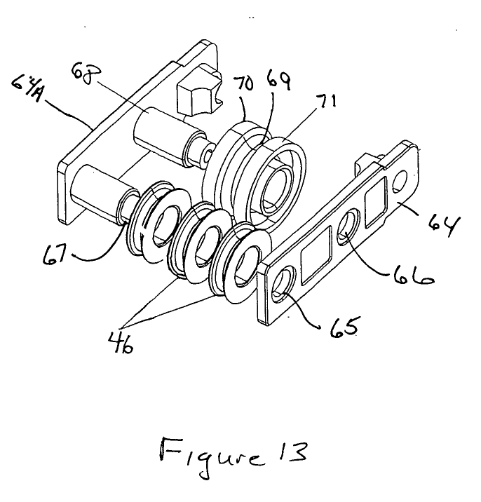

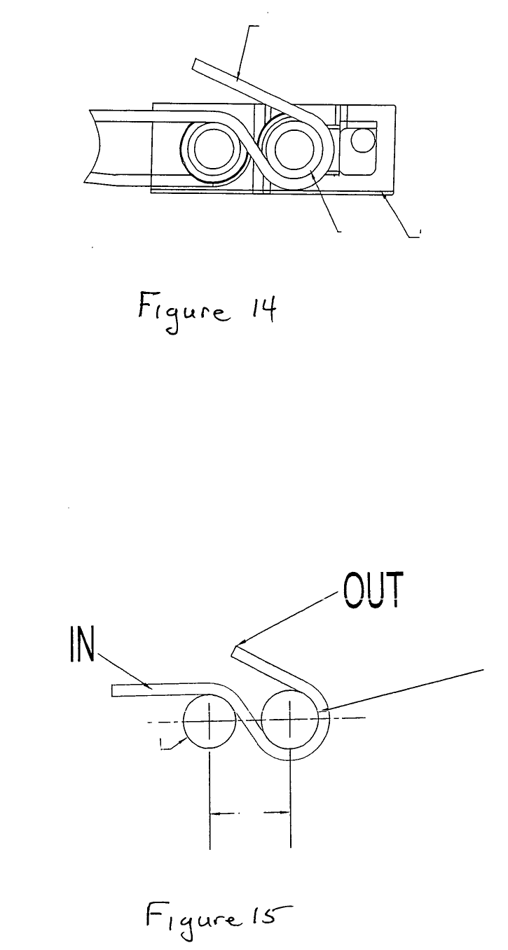

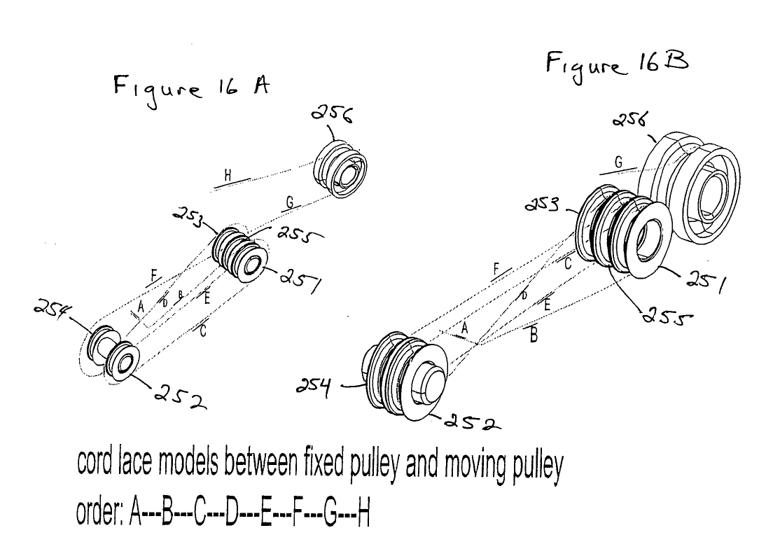

In FIG. 16A starting at end A the cord B is wrapped over the roller 251 on the first fixed pulley assembly axle and under the bottom of roller 251 and extending C to right roller 252 on the movable pulley assembly. The cord goes under the right roller 252. When it reaches the top side it crosses D over to the left roller 253 on the first axle of the fixed pulley assembly where it goes under roller 253 and comes out under the bottom where the cord extends E to the left roller 254 on the movable pulley assembly. The cord goes under the bottom of roller 254 and comes from the top of left roller 254 where it extends F to the center roller 255 of the first axle of the fixed pulley assembly. The cord goes over the center roller 255 of the axle and then passes G under roller 256 on the second axle of the fixed pulley assembly where it ends at H.

In FIG. 16B starting at end A the cord B is wrapped over the roller 251 on the first fixed pulley assembly axle and over the bottom of roller 251 and extending C to right roller 252 on the movable pulley assembly. The cord goes over the right roller 252. When it reaches the top side it crosses D over to the left roller 253 on the first axle of the fixed pulley assembly where it goes over roller 253 and comes out under the bottom E where the cord extends to the left roller 254 on the movable pulley assembly. The cord goes over the bottom of roller 254 and comes from the top of left roller 254 where it extends F to the center roller 255 of the first axle of the fixed pulley assembly. The cord goes over the center roller 255 of the axle and then passes G under roller 256 on the second axle of the fixed pulley assembly where it ends at H.

1. A window balance system comprising a U-shaped channel said U-shaped channel having a base and two sidewalls extending upwardly from said base said U-shaped channel having a spring having a first end and a second end, said second end of said spring being secured to said channel in an area at a first end of said channel, said second end of said spring being secured to a movable pulley assembly in said channel, said movable pulley assembly having at least one roller rotatable mounted therein, said movable pulley assembly being secured to a fixed pulley assembly by means of a thread that passes along said roller on said movable pulley assembly and rollers on said fixed pulley assembly, said fixed pulley assembly having two or more rollers rotatably mounted in a first position in said fixed pulley assembly and at least a second roller rotably mounted in a second position in said fixed pulled assembly.

2. The window balance system according to claim 1 where in said first position on said fixed pulley assembly has a left roller, center roller, and a right roller rotatably mounted thereon.

3. The window balance system according to claim 2 wherein said movable pulled assembly has a left and a right roller.

4. The window balance system according to claim 3 wherein said first position has three rollers on a single axis.

5. The window balance system according to claim 4 wherein said second position on said fixed pulley assembly has two rollers.

6. The window balance system according to claim 2 wherein said first position on said fixed pulley assembly and said second position on said fixed pulley assembly are positioned in said fixed pulley assembly such that axles for the rollers in each position are parallel to each other.

7. The window balance system according to claim 6 where in the axle of said second position is closer to an end of said u-shaped channel than said first position.

8. The window balance system according to claim 7 wherein an axle of the roller in said movable pulley assembly is parallel to the axles of said fixed pulley assembly.

9. The window balance system according to claim 8 wherein said balance system is an inverted balance system.

10. The window balance system according to claim 8 wherein said balance system is a tilt balance system.

11. The window balance system according to claim 8 wherein said balance is a side load balance system.

12. The system according to claim 1 wherein said U-shaped channel has one or more corrugations on at least one of said base or said sidewalls.

13. The system according to claim 1 wherein said U-shaped channel has one or more dimples on at least one of said base or said sidewalls.

14. A channel for a window balance system comprising a base and two sidewalls, said sidewalls extending upwardly from said base at generally right angles to said base, said sidewalls having an inner and outer surface, said base having an inner and outer surface, and wherein at least one of said outer surfaces of said sidewalls and said base having a plurality of corrugations in the surface thereof.

15. The channel according to claim 14 wherein said corrugation comprises a first sidewall and second sidewall, and wherein said first sidewall meets said second sidewall at an angle.

16. The channel according to claim 14 wherein said base has said corrugation.

17. The channel according to claim 14 wherein said sidewalls have said corrugations.

18. A channel for a window balance system comprising a base and two sidewalls, said sidewalls extending upwardly from said base at generally right angles to said base, said sidewalls having an inner and outer surface, said base having an inner and outer surface, and wherein at least one of said outer surfaces of said sidewalls and said base having a plurality of dimples in the surface thereof.

19. The channel according to claim 18 wherein said dimple comprises a first and second side wall, and a top surface.

20. The channel according to claim 18 wherein said base has said dimple.

21. The channel according to claim 18 wherein said sidewalls have said dimple.

22. The channel according to claim 18 wherein said plurality of dimples extend inwardly toward the surface of which they are attached.

23. The channel according to claim 18 wherein said plurality of dimples extend outwardly toward the surface of which they are attached.

24. The channel according to claim 14 wherein said sidewalls have one or protruding members which provide a suitable means for securing a fixed pulley member to said channel.

25. The channel according claim 18 wherein said protruding members which provide a suitable means for securing a balance shoe device.

26. The channel according to claim 14 wherein said first and second side wall of said corrugations are curved inwardly toward the surface of which they are attached.

27. The channel according to claim 14 wherein said first and second side wall of said corrugations are curved outwardly toward the surface of which they are attached.

28. The channel according to claim 14 wherein said sidewalls have fins extending outwardly from said outer surface of said sidewalls.

29. The channel according to claim 14 wherein said sidewalls have fins extending inwardly from said outer surface of said sidewalls.

30. The channel according to claim 18 wherein said dimples are aligned horizontally to form one or more straight lines.

31. The channel according to claim 18 wherein said dimples are aligned vertically to form one or more straight lines.

32. The window balance system according to claim 9 threaded wherein said thread wraps under and extends over said right roller of said first axle of said fixed pulley assembly and extends towards said right roller of said moveable pulley assembly, said thread wraps over and extends under said right roller of said moveable pulley assembly, said thread crosses over from over said right roller of said moveable pulley assembly to said left roller of said first axle of said fixed pulley assembly, said thread wraps under and extends over said left roller of said first axle of said fixed pulley assembly and extends towards said left roller of said movable pulley assembly, said thread wraps over and extends under said left roller of said movable pulley assembly towards said center roller of said first axle of said fixed pulley assembly, said thread wraps under said center roller of said first axle of said fixed pulley assembly towards said center roller of said second axel of said fixed pulley assembly, said thread wraps over said center roller of said second axel of said fixed pulley assembly.

33. A window balance system according to claim 9 threaded wherein said thread wraps over and extends under said right roller of said first axle of said fixed pulley assembly towards said right roller of said moveable pulley assembly, said thread wraps under and extends over said right roller of said moveable pulley assembly, said thread crosses over from over said right roller of said moveable pulley assembly to said left roller of said first axle of said fixed pulley assembly where it wraps over and extends under said left roller towards said left roller of said movable pulley assembly, said thread wraps over and under said left roller of said movable pulley assembly and extends towards said center roller of said first axle of said fixed pulley assembly, said thread wraps under said center roller of said first axle of said fixed pulley assembly towards said center roller of said second axel of said fixed pulley assembly, said thread extends under center roller of said second axel of said fixed pulley assembly.

34. A window balance system according to claim 10 that is threaded wherein said thread wraps over and extends under said right roller of said first axle of said fixed pulley assembly towards said right roller of said moveable pulley assembly, said thread wraps under and extends over said right roller of said moveable pulley assembly, said thread crosses over from over said right roller of said moveable pulley assembly to said left roller of said first axle of said fixed pulley assembly, said thread wraps over and wraps under said first axle of said left roller of said fixed pulley assembly and extends towards said left roller of said movable pulley assembly, said thread wraps under and extends over said left roller of said movable pulley assembly extending towards said center roller of said first axle of said fixed pulley assembly, said thread wraps over said center roller of said first axle of said fixed pulley assembly and extends towards said center roller of said second axle of said fixed pulley assembly, said thread wraps under said center roller of said second axle of said fixed pulley assembly.

35. A window balance system according to claim 10 that is threaded wherein said thread is wraps under and extends over said right roller of said first axle of said fixed pulley assembly towards said right roller of said moveable pulley assembly, said thread extending over said and wrapping under said right roller of said moveable pulley assembly, said thread crosses over from over said right roller of said moveable pulley assembly to said left roller of said first axle of said fixed pulley assembly, said thread extending from under said left roller of said fixed pulley assembly extending over said left roller of said fixed pulley assembly towards said left roller of said movable pulley assembly, said thread wraps over and extends under said left roller of said movable pulley assembly, said thread extending from under said left roller of said movable pulley assembly towards said center roller of said first axle of said fixed pulley assembly, said thread wraps over and under said center roller of said first axle of said fixed pulley assembly towards said center roller of said second axle, said thread wraps under said center roller of said second axle of said fixed pulley assembly.

36. A method A window balance system according to claim 11 that is threaded wherein said thread wraps over and extends under said right roller of said first axle of said fixed pulley assembly towards said right roller of said moveable pulley assembly, said thread extends under and wraps over said right roller of said moveable pulley assembly and crosses over to said left roller of said fixed pulley assembly, said thread wraps over said left roller of said fixed pulley assembly and extends-towards said left roller of said movable pulley assembly, said thread wraps over said left roller of said movable pulley assembly and extending towards said center roller of said first axle of said fixed pulley assembly, said thread wraps over and under said center roller of said first axle of said fixed pulley assembly and extends towards said center roller of said second axle of said fixed pulley assembly, said thread wraps under said center roller of said second axle of said fixed pulley assembly.

37. A window balance system according to claim 11 that is threaded wherein said thread wraps over and extends under said right roller of said first axle of said fixed pulley assembly towards said right roller of said moveable pulley assembly, said thread extends under and wraps over said right roller of said moveable pulley assembly and crosses over to said left roller of said fixed pulley assembly, said thread wraps over and extends under said left roller of said fixed pulley assembly towards said left roller of said movable pulley assembly, said thread wraps under and extends over said left roller of said movable pulley assembly, said thread wraps over and under said center roller of said first axle of said fixed pulley assembly and extends to under said center roller of said second axle of said fixed pulley assembly.
